(19) United States
(12) Patent Application Publication
(10) Pub. No.: US 2006/0145970 A1
(43) Pub. Date: Jul. 6, 2006

(54) Matrix display device

(75) Inventors: Marcellinus Petrus Carolus Michael Krijn, Eindhoven (NL); Franciscus Paulus Maria Budzelaar, Eindhoven (NL); Jurgen Jean Louis Hoppenbrouwers, Eindhoven (NL); Maurizio Maiani, Eindhoven (NL); Johannes Josephus Wilhelmus Maria Rosink, Eindhoven (NL); Bart Andre Salters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/545,058

(22) PCT Filed: Jan. 30, 2004
(86) PCT No.: PCT/IB04/50067

§ 371 Date: Aug. 10, 2005

(30) Foreign Application Priority Data
Feb. 13, 2003 (EP) 03100320.5

(51) Int. Cl. G09G 3/30

(52) U.S. Cl. 345/81

(57) ABSTRACT

A matrix display device comprises a matrix of optically addressable pixels (Pij) which comprise a light sensitive element (LSij) and a pixel light generating element (LGij). The light generating element (LGij) will produce a pixel light (LMij) with a brightness which depends on the state of the light sensitive element (LSij). The state of the light sensitive element (LSij) depends on the amount of light impinging on it. The actual brightness of the pixel light generating element (LGij) may further depend on a voltage across it. The pixels (Pij) are constructed such that a portion of the pixel light (PLMij) generated by the pixel light generating element (LGij) reaches the associated light sensitive element (LSij) of the pixel (Pij). The light sensitive element (LSij) is sensitive to the portion of the pixel light (PLMij) to obtain a feedback of the portion of the pixel light (PLMij) to the light sensitive element (LSij). This feedback may be used to obtain a memory behavior of the pixel (Pij) or to influence an intrinsic memory behavior of the pixel (Pij).

The invention relates to an active matrix display, and a display apparatus comprising a matrix display.

U.S. Pat. No. 6,215,462 discloses a matrix display device with a plurality of rows of pixels. The rows of the matrix display are selected one by one. Each row is associated with a light waveguide which transports light generated by a first light emission element to the pixels of the row. A particular row is selected if the associated select light emission element produces light; all the other rows are not selected because their associated select light emission elements do not produce light.

Each pixel comprises a series arrangement of a light sensitive element and a pixel light emission element. A data voltage in accordance with the image data to be displayed is supplied to the series arrangement via column conductors. In the selected row of pixels, the light generated by the select light emission element associated with the selected row reaches the pixels of the selected row via the associated light waveguide. Consequently, the light sensitive elements of the pixels of the selected row have a low impedance, and the data voltage occurs substantially over the pixel light emission elements of the pixels of the selected row. Thus, the selected row of pixels will generate an amount of light in accordance with the image data presented on the column conductors which each are connected to a column of pixels. In the rows which are not selected, the select light emission elements do not produce light, and thus the impedance of the light sensitive elements of not selected pixels is high. For these pixels, the data voltage will substantially occur across the high impedance of the light sensitive elements, and consequently, the voltage across the pixel light emission elements will be below a threshold value such that the pixel light emission elements will not produce light.

It is an object of the invention to provide a matrix display with an increased brightness.

A first aspect of the invention provides a matrix display as claimed in claim 1. A second aspect of the invention provides a display apparatus as claimed in claim 10. Advantageous embodiments are defined in the dependent claims.

The matrix display device in accordance with the first aspect of the invention comprises a matrix of optically addressable pixels. The pixels comprise a light sensitive element and a pixel light generating element. The light generating element will produce a pixel light with a brightness which depends on the state of the light sensitive element. The state of the light sensitive element depends on the brightness of light impinging on it. The actual brightness of the pixel light generating element may further depend on a pixel voltage across it.

The pixels are constructed such that in a pixel a portion of the pixel light generated by the pixel light generating element reaches the associated light sensitive element of the pixel. The light sensitive element is sensitive to the pixel light to obtain an optical feedback of the portion of the pixel light to the light sensitive element.

This feedback may be used to obtain a memory behavior of the pixel or to influence the memory behavior of the pixel. With respect to the prior art U.S. Pat. No. 6,215,462, the memory behavior of the pixel will cause the pixel which is switched on during an addressing period to stay on after the addressing period. The pixel will generate light during substantially the whole frame period and not only during the addressing period, and consequently its brightness increases.

The optical feedback may also be used to influence an intrinsic memory behavior of a pixel caused by a capacitance of the pixel. The portion of the light impinging on the light sensitive element is used to discharge the capacitance, as is defined in the embodiment of the invention of claim 5.

In an embodiment in accordance with the invention as claimed in claim 2, the pixel voltage is supplied across a series arrangement of the pixel light generating element and an impedance element of which the impedance depends on the state of the light sensitive element. If the pixel voltage has a sufficiently high level and the impedance of the impedance element is low, the pixel light generating element will generate light because the pixel voltage is substantially present across it. If the pixel voltage has a sufficiently high level and the impedance of the impedance element is high, the pixel light generating element will not generate light because the pixel voltage is substantially present across the light sensitive element.

The brightness of the portion of the light generated by the pixel light generating element which impinges on the associated light sensitive element is sufficiently high to keep the impedance of the impedance element relatively low with respect to the impedance of the pixel light generating element. Thus, if the pixel light emitting element is brought in a state in which it emits light, a portion of this light will keep or bring the light sensitive element in a state in which the pixel light emitting element stays in the light emitting state.

In an embodiment in accordance with the invention defined in claim 3, the light sensitive element itself is arranged in series with the pixel light generating element. If the impedance of the light sensitive element is low with respect to the impedance of the pixel light generating element, the pixel voltage supplied across the series arrangement of the light sensitive element and the pixel light generating element will substantially occur across the pixel light generating element and thus determine its brightness. If the impedance of the light sensitive element is high with respect to the impedance of the pixel light generating element, the pixel voltage will substantially occur across the light sensitive element and the pixel light generating element will have a substantial zero brightness.

Once the impedance of the light sensitive element is low, the pixel light generating element produces light of which a portion is received by the light sensitive element. As this portion of the light is sufficient to keep the impedance of the light sensitive element low, a memory behavior of the pixel is obtained. Thus, once the pixel light generating element produces light, the state of the light sensitive element will be kept in the state keeping the pixel light generating element in the light emitting state. Thus, the pixel will continue to generate light when another line of pixels is addressed and consequently, the brightness of the display is improved.

Thus, if the pixel light emitting element is brought in a state in which it emits light, a portion of this light will keep or bring the light sensitive element in a state in which the pixel light emitting element stays in the light emitting state.

In an embodiment in accordance with the invention defined in claim 4, a switching element has a main current path arranged in series with the pixel light generating element and a control electrode coupled to the light sensitive element. This has the advantage that the impedance of the light sensitive element is less important. If light of the pixel light generating element impinges on the light sensitive element its impedance changes, which causes the switching element to get a low impedance. Thus, again a memory behavior of the pixel is obtained.

In an embodiment in accordance with the invention defined in claim 5, the matrix display further comprises an control light generating device which generates control light which is directed towards the light sensitive elements of the pixels. The control light generating device supplies light to the light sensitive elements of the pixels which should produce light, and the control light generating element supplies no light to the light sensitive elements of the pixels which should not produce light.

It is possible to supply the same voltage across the series arrangement of the pixel light generating element and the series impedance for all the pixels. The series impedance may be the light sensitive element or the main current path of the switch which is controlled by the light sensitive element. The pixels may be driven in a bi-stable manner: if the light sensitive element of a particular pixel receives light from the control light generating device, the corresponding pixel light generating element will produce light, if the light sensitive element of a particular pixel receives no light from the control light generating device, the corresponding pixel light generating element will not produce light. It is possible to vary the pixel voltage across the series arrangement per pixel to vary the brightness produced by the pixel light generating element per pixel.

In an embodiment in accordance with the invention defined in claim 6, the light generated by a plurality of control light generating elements is transported to lines of pixels via light waveguides. For each line of pixels only one control light generating element is used. The control light produced by the control light generating element can be used to perform the selecting of the line of pixels. The line of pixels associated with one of the control light generating elements may extend in the row or column direction of the matrix display.

The addressing of the complete matrix of pixels is elucidated in the now following. If for example, for the ease of elucidation, the light waveguides extend in the column direction, and the rows of the matrix display are selected one by one with the pixel voltage. A row is selected by supplying a high level pixel voltage across the series arrangement of the pixel light generating element and the series impedance of the pixels of the selected row. The other rows are not selected because a low level pixel voltage is supplied across the series arrangements of the pixels of not-selected rows. The rows and columns may be interchanged. The high level pixel voltage is selected such that the pixel light generating element of the pixel which receives control light will emit light while a pixel light generating element of a pixel which does not receive control light will not emit light. The low voltage is selected such that pixels which were addressed earlier to produce light still will produce light while pixels which were addressed earlier to not produce light will not start producing light. Thus, the pixels in the selected row can be switched on or off by the control light, while the state of the pixels in not selected rows is unaltered.

In an embodiment in accordance with the invention defined in claim 7, the control light generating device comprises a laser for scanning along the light sensitive elements of the pixels. The laser obviates the multiple light generating elements and light-waveguides otherwise required.

In an embodiment in accordance with the invention defined in claim 8, the control light generating device directs the control light towards the further light sensitive element. A short light pulse from the control light generating device suffices to charge the capacitor via the further switching element. The capacitor is discharged by the light sensitive element which receives a portion of the pixel light from the pixel light generating element.

In this manner, the behavior a phosphor of a cathode ray tube is imitated: in response to the control light pulse, the pixel starts with a high brightness which gradually decreases. The value of the capacitor determines the time during which the brightness decreases to zero. The brightness and/or duration of the control light pulse determine the peak brightness of the pixel. Further, it is an advantage that the brightness of the pixel is substantially independent on the quality of the pixel light generating element if this is a (Poly) LED (light emitting diode). If the (poly) LED does not function well, it will take longer to discharge the capacitor, and thus, the net amount of light produced is substantially equal.

Thus, now the intrinsic memory behavior of the pixels is influenced by the feedback of the portion of the light generated by the pixel light generating element which impinges on the light sensitive element.

These and other aspects of the invention are apparent from and will be elucidated with reference to the embodiments described hereinafter.

In the drawings:

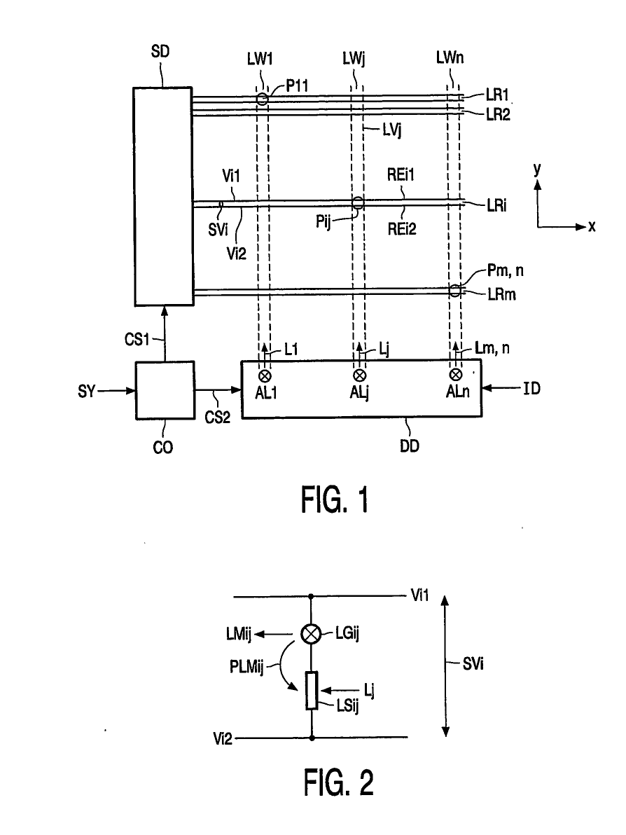

FIG. 1 shows an embodiment of a matrix display apparatus with optically addressed display cells having an optical feedback to obtain a memory effect of the pixels,

FIG. 2 shows an embodiment of a display cell in accordance with the invention,

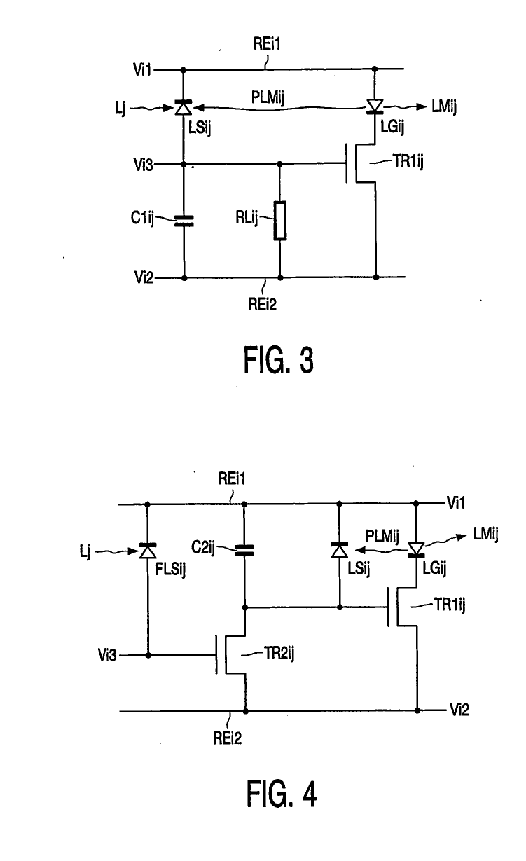

FIG. 3 shows another embodiment of a display cell in accordance with the invention,

FIG. 4 shows another embodiment of a display cell in accordance with the invention, and

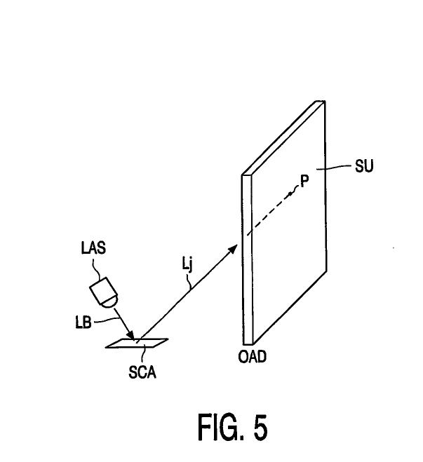

FIG. 5 shows a display apparatus in accordance with the invention wherein the display cells are addressed with a laser.

The same references in different Figs. refer to the same signals or to the same elements performing the same function.

FIG. 1 shows an embodiment of a matrix display apparatus with optically addressed display cells having an optical feedback to obtain a memory effect of the pixels.

The matrix display comprises a matrix of pixels Pij (P11 to Pmn) which are associated with intersections of light-waveguides LWj (LW1 to LWn) and sets of two row electrodes REi1, REi2. The index i indicates the row number, the index j indicates the column number of the matrix display. The row electrodes REi1 and REi2 extend in the x-direction, the light-waveguides LWj extend in the y-direction. In a transposed matrix display, the x and y direction are interchanged.

A select driver SD supplies row voltages Vi1 to the row electrodes REi1 and row voltages Vi2 to the row electrodes REi2. The pixel voltage SVi occurs between the row electrode REi1 and the row electrode REi2 of the i^{th} row.

A data driver DD receives input data ID to be displayed and control light generating elements ALj which produce an control light Lj with a brightness depending on the input data ID and which cooperate with the light waveguides LWj to supply the control light Lj generated to the light sensitive elements LSij, FLSij (see FIGS. 2 to 4) of the pixels Pij.

A control circuit CO receives synchronization information SY to supply a control signal CS1 to the select driver SD to select the rows LRi of pixels Pij one by one, and a control signal CS2 to the data driver DD to supply the data for the selected row LRi.

The pixels Pij may be formed in a substrate (not shown), the row electrodes REi1 and the row electrodes REi2 may be present at opposite sides of the substrate. One of the row electrodes REi1 or REi2 may be structured as an electrode plate instead of separated electrodes which extend in the row direction.

FIG. 2 shows an embodiment of a display cell in accordance with the invention. In FIG. 2, the display cell or pixel Pij comprise a series arrangement of a pixel light generating element LGij and a light sensitive element LSij of which an impedance depends on the brightness of light received. The series arrangement of the pixel light generating element LGij and the light sensitive element LSij is arranged between the first row electrode REi1 and the second row electrode REi2 to receive the pixel voltage SVi. The voltage on the first row electrode REi1 is denoted by Vi1, the voltage on the second row electrode REi2 is denoted by Vi2, the pixel voltage SVi is the difference of the voltages Vi1 and Vi2. A portion of the pixel light PLMij produced by the pixel light generating element LGij will reach the light sensitive element LSij.

The operation of the pixel Pij is elucidated in the now following. The brightness of light falling onto the light sensitive element LSij is the combination of the portion of the pixel light PLMij generated by the pixel light generating element LGij and the control light Lj during the addressing period during which the pixel Pij is addressed.

Initially, the pixel Pij is in the off state, even if a considerable pixel voltage SVi is present across the series arrangement. The high impedance of the light sensitive element LSij causes the pixel voltage SVi to be substantially present over the light sensitive element LSij, and thus a substantially zero voltage is present across the pixel light generating element LGij.

If a particular pixel Pij should produce light during the addressing period when a row of pixels Pij is addressed, the control light generating element ALj will emit control light Lj which reaches the light sensitive element LSij. The impedance of the light sensitive element LSij will become low with respect to the impedance of the pixel light generating element LGij and the pixel voltage SVi will be substantially present across the pixel light generating element LGij. The pixel light generating element LGij will start to emit the pixel light LMij. Upon switching off the control light Lj, the pixel Pij remains in the on-state since the portion of the light PLMij generated by the pixel light generating element LGij is captured by the light sensitive element LSij which keeps it impedance low. The pixel Pij is switched off by reducing the pixel voltage SVi below a threshold value. The pixel Pij thus has an in-built memory brought about by optical feedback to the light sensitive element LSij.

If a particular pixel Pij should not produce light during the addressing period when a row of pixels is addressed, the control light generating element ALj will not emit control light Lj and the impedance of the light sensitive element LSij will stay high.

To drive a complete matrix display with a video signal, all the pixels Pij have to be addressed during a field period to provide a field of input video data ID during this field period to the pixels Pij. The next field of input data ID is supplied to the pixels Pij during the next field period. During a field period, the rows of the matrix display are selected one by one.

Before writing data to the pixels Pij first all pixels Pij have to be reset to produce no light. This is possible by reducing the pixel voltage SVi below a threshold value for all the rows. Then, a particular row is selected during a line select period (also referred to as line address period, or the addressing period of the pixels) by supplying a pixel voltage SVi to this row which is sufficiently high. At the same time the control light generating elements ALj are activated to produce control light Lj for the columns that correspond to the pixel positions within the addressed row that are required to be switched to the on-state wherein the pixel light generating element LGij should emit light. Next, at the end of the line select period, the pixel voltage SVi is lowered to a value that is sufficient to sustain the pixels Pij within this row, but that is too low to readdress the pixels Pij. Thus the pixel voltage SVi in not selected rows is too low to alter the state of the pixels Pij but not so low that the pixels Pij are reset.

If more grey scales are required it is possible to use the well known sub-field drive method. Each subfield of the field period can be addressed in the same manner as elucidated above for a field period.

The pixel light generating elements LGij and the control light generating elements ALj may, for example, comprise small lasers, LED's (light emitting diodes), OLED's (Organic LED's), PolyLED's, small incandescent lamps or fluorescent lamps, or light generating elements as used in plasma displays. The light sensitive elements may, for example, comprise LDR's (light dependent resistors), or LAS (light activated thyristors or other light activated electronic switches).

Such an optical addressed display is inexpensive and relatively easy to manufacture compared to an LCD. The dimensions are easily scalable, only simple two terminal memory elements are required, and a high lumen efficacy is possible.

FIG. 3 shows another embodiment of a display cell in accordance with the invention. The pixel light generating element LGij is arranged in series with the main current path of a transistor TR1ij between the first row electrode REi1 and the second row electrode REi2. The voltage on the first row electrode REi1 is denoted by Vi1, the voltage on the second row electrode REi2 is denoted by Vi2, the pixel voltage SVi is the difference of the voltages Vi1 and Vi2. The light sensitive element LSij is arranged between the control electrode of the transistor TR1ij and the first row electrode REi1. An optional capacitor C1ij is arranged between the control electrode of the transistor TR1ij and the second row electrode REi2. An optional leakage resistor RLij is also arranged between the control electrode of the transistor TR1ij and the second row electrode REi2.

If control light Lj impinges on the light sensitive element LSij, the transistor TR1ij becomes low-ohmic and the pixel voltage VSi is substantially present across the pixel light generating element LGij which starts emitting pixel light LMij. A portion of the pixel light PLMij impinges on the light sensitive element LSij which thus will keep the pixel in the on-state even when the control light Lj is not anymore supplied. The pixel light generating element LGij will stop emitting light when the pixel voltage SVi drops below a particular value. The pixel light generating element LGij can also be switched off (or on) with the voltage Vi3.

The capacitor C1ij buffers the voltage on the control electrode of the transistor TR1ij and provides a memory behavior. The resistor RLij discharges the capacitor and thus determines the time constant of the memory.

FIG. 4 shows another embodiment of a display cell in accordance with the invention. The pixel light generating element LGij is arranged in series with the main current path of a transistor TR1ij between the row electrode REi1 and the row electrode REi2. The voltage on the row electrode REi1 is denoted by Vi1, the voltage on the row electrode REi2 is denoted by Vi2, the pixel voltage SVi is the difference of the voltages Vi1 and Vi2. The light sensitive element LSij is arranged between the control electrode of the transistor TR1ij and the row electrode REi1. An optional capacitor C2ij is arranged between the control electrode of the transistor TR1ij and the row electrode REi1. A main current path of a transistor TR2ij is arranged between the control electrode of the transistor TR1ij and the second row electrode REi2. A light sensitive element FLSij is arranged between the control electrode of the transistor TR2ij and the row electrode REi1.

If a short control light pulse Lj impinges on the light sensitive element FLSij, the transistor TR2ij becomes low-ohmic and the capacitor C2ij is charged to the pixel voltage VSi. The transistor TR1ij starts conducting and the pixel light generating element LGij starts emitting pixel light LMij. The charge on the capacitor C2ij will keep the transistor TR1ij conductive. A portion of the pixel light PLMij impinges on the light sensitive element LSij which will discharge the capacitor C2ij. The impedance of the transistor TR1ij will gradually increase. In this manner, the behavior a phosphor of a cathode ray tube is imitated: in response to the control light pulse Lj, the pixel Pij starts with a high brightness which gradually decreases. The value of the capacitor C2ij determines the time during which the brightness decreases to zero. The brightness and/or duration of the control light pulse Lj determine the peak brightness of the pixel Pij. Further, it is an advantage that the brightness of the pixel Pij is substantially independent on the quality of the pixel light generating element if this is a (Poly) LED (light emitting diode). If the (poly) LED does not function well, it well take longer to discharge the capacitor C2ij, and thus, the net amount of light produced is substantially equal.

It possible to switch the pixel Pij off with the voltage Vi3 at the control electrode of the transistor TR2ij.

The optional parallel arrangement of the capacitor C3ij and the resistor R3ij is arranged between the control electrode of the transistor TR2ij and the electrode REi2. This parallel arrangement integrates the effect of the light pulse Lj.

FIG. 5 shows a display apparatus in accordance with the invention wherein the display cells are addressed with a laser. The optical addressable display device OAD comprises the pixels Pij and the row electrodes REi1 and REi2 as shown in FIG. 1. Usually the pixels Pij are integrated in a substrate SU while the row electrodes REi1 and REi2 are present at opposite sides of the substrate SU. The light waveguides LWj are not present.

In the embodiment in accordance with the invention as shown in FIG. 1, the optical state of the pixels Pij is controlled by the control light Lj generated by the control light generating elements ALj which control light Lj is transported via the light-waveguides LWj to the light sensitive elements LSij of FIG. 2 or the light sensitive elements FLSij of FIG. 4.

In the embodiment in accordance with the invention as shown in FIG. 5, a laser LAS generates the control light Lj which has to impinge on the light sensitive elements LSij of FIG. 2 or the light sensitive elements FLSij of FIG. 4. The scanning of the laser beam LB produced by the laser LAS may be controlled with an x/y scanner SCA. This x/y scanner SCA is mechanically moveable to scan the laser beam LB along the light sensitive elements LSij or FLSij of the display OAD. Preferably, the laser beam LB scans over the rows LRi of the pixels Pij one by one. It is also possible to use more than one laser beam LB.

The laser scanning simplifies the construction of the display because the light-waveguides LWj and the multiple control light generating elements ALj are not required. Further, the data driver DD becomes less complex as a single drive signal for a single laser LAS has to be generated instead of the large amount of drive signals, one for each control light generating element ALj. In a preferred embodiment, the laser LAS is only used to address the pixels Pij and not to generate gray scales. Consequently, a simple diode laser suffices.

The display OAD has a simple construction and thus can be produced easy and cheap. The display OAD may even be a foil. The laser LAS may scan the rear or the front of the display OAD. Rear projection has the advantage that it is easy to prevent the ambient light to reach the light sensitive elements LSij or FLSij. In a front projector, a filter layer in the display OAD has to cover the light sensitive elements LSij or FLSij such that the ambient light is sufficiently blocked and does not influence the state of the pixels Pij, while the laser beam is able to sufficiently pass the filter to be able to control the state of the pixels Pij. It is also possible to use light sensitive elements LSij which are sensitive to the laser light but not to the ambient light.

In a color display, the position of the laser beam LB on the display screen needs to be known to synchronize the intensity of the laser beam LB corresponding to the video information with the position of the Red, Green and Blue pixels of the display OAD.

It should be noted that the above-mentioned embodiments illustrate rather than limit the invention, and that those skilled in the art will be able to design many alternative embodiments without departing from the scope of the appended claims.

For example, the transistors which are shown to be MOSFETS, may also be bipolar transistors. All the transistors may be of the opposite conductivity type, the circuits have to be adapted in a manner known to the skilled person. The transistors may be based on inorganic materials (such as silicon) or organic materials.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A matrix display device with a matrix of optically addressable pixels (Pij) comprising a pixel light generating element (LGij) for generating pixel light (LMij), and a light sensitive element (LSij) being sensitive to the pixel light (LMij), wherein the light sensitive element (LSij) and the pixel light generating element (LGij) are positioned with respect to each other to enable pixel light (LMij) generated by the pixel light generating element (LGij) to reach the light sensitive element (LSij) to obtain an optical feedback of a portion of the pixel light (PLMij) from the pixel light generating element (LGij) to the light sensitive element (LSij).

2. A matrix display as claimed in claim 1, wherein the pixel light generating element (LGij) and an impedance element (LSij; TR1ij) are arranged in series, an impedance of the impedance element (LSij; TR1ij) being dependent on a state of the light sensitive element (LSij), and wherein the matrix display further comprises a pixel driver (SD, DD) for supplying a pixel voltage (SVi) to the series arrangement of the impedance element (LSij; TR1ij) and the pixel light generating element (LGij).

3. A matrix display device as claimed in claim 1, wherein the impedance element (LSij; TR1ij) comprises the light sensitive element (LSij), and wherein the portion of the pixel light (PLMij) reaching the light sensitive element (LSij) is sufficient for keeping an impedance of the light sensitive element (LSij) relatively low with respect to an impedance of the pixel light generating element (LGij).

4. A matrix display device as claimed in claim 2, wherein the impedance element comprise a switching element (TR1ij) having a main current path arranged in series with the pixel light generating element (LGij), and having a control electrode coupled to the light sensitive element (LSij), and wherein the portion of the pixel light (PLMij) reaching the light sensitive element (LSij) is sufficient for obtaining an impedance of the switching element (TR1ij) being relatively low with respect to an impedance of the pixel light generating element (LGij).

5. A matrix display device as claimed in claim 1, wherein the display device comprises an control light generating device (ALj; LAS) for generating control light (Lj) being directed towards the light sensitive element (LSij) of the optically addressable pixels (Pij) to address the pixels (Pij).

6. A matrix display device as claimed in claim 5, wherein the control light generating device (ALj) comprises a plurality of light generating elements (ALj) and light waveguides (LWj) for transporting the light (Lj) generated by the plurality of light generating elements (ALj) to lines (LVj) of the pixels (Pij).

7. A matrix display device as claimed in claim 5, wherein the control light generating device (ALj; LAS) comprises a laser (LAS) for generating a laser beam, and deflection means (SCA) for scanning the laser beam along the light sensitive elements (LSij) of the pixels (Pij).

8. A matrix display device as claimed in claim 5, wherein the display device comprises an control light generating element (ALj) for generating control light (Lj) being directed towards the optically addressable pixels (Pij) to address the pixels (Pij), and wherein the pixels (Pij) further comprise:
a further light sensitive element (FLSij) for receiving the control light (Lj),
a capacitor (C2ij) coupled to the control electrode of the switching element (TR1ij), and
a further switching element (TR2ij) having a control electrode coupled to the further light sensitive element (FLSij) and a main current path coupled to the control electrode of the first mentioned switching element (TR1ij).

9. A matrix display device as claimed in claim 1, wherein the light sensitive element (LSij) is a light-dependent resistor or a light-activated switch.

10. A display apparatus comprising a matrix display as claimed in claim 1 wherein the pixels (Pij) are arranged in successive lines (LRi) extending in a first direction (x), and the further light generating elements (Lj) are associated with lines (LVj) of pixels (Pij) extending in a second direction (y) substantially perpendicular to the first direction (x), and wherein the display apparatus further comprises:
a select driver (SD) for supplying pixel voltages (SVi) to the pixels (Pij) of the lines (LRi) of pixels (Pij) extending in the first direction (x) to select the pixels (Pij) of the lines (LRi) of pixels (Pij) extending in the first direction (x) line by line,
a data driver (DD) for activating the further light generating elements (ALj) to supply light in accordance with display data (ID) to be displayed to the light sensitive elements (LSij) of the lines (LVj) of the pixels (Pij) extending in the second direction (y).

11. A display apparatus as claimed in claim 9, wherein one of the pixel voltages (SVi) associated with a selected one of the lines (LRi) are selected sufficiently high to enable the pixel light generating element (LGij) to produce light (LMij; FLMij) when the light (Lj) of the further light generating element (ALj) reaches the associated light sensitive element (LSij), and to produce no light when no light is received from the further light generating element (ALj), while pixel voltages (SVi) associated with not selected lines (LRi) is both not high enough and not too low to alter a state of the associated pixel light generating element (LGij).
